(19) United States
(12) Patent Application Publication
(10) Pub. No.: US 2022/0289543 A1
(43) Pub. Date: Sep. 15, 2022

(54) OPERATION PANEL FOR AERIAL WORK VEHICLES

(71) Applicant: HOKUETSU INDUSTRIES CO., LTD., Niigata (JP)

(72) Inventors: Norihide IKARASHI, Niigata (JP); Masahiko WATANABE, Niigata (JP); Masaki HIWATASHI, Niigata (JP)

(21) Appl. No.: 17/632,619

(22) PCT Filed: Aug. 27, 2020
(86) PCT No.: PCT/JP2020/032411

§ 371 Date: Feb. 3, 2022

(30) Foreign Application Priority Data
Aug. 29, 2019 (JP) 2019-157318

(51) Int. Cl. B66F 9/24; B66F 11/04

(52) U.S. Cl. CPC B66F 9/24; B66F 11/04

(57) ABSTRACT

An operation panel for aerial work vehicles that can be operated by one hand and removable from a deck and used as a remote control. The operation panel body of an operation panel equipped with a driving operation device is detachably mounted on a deck, the driving operation device being provided with: a control stick capable of tilting back/forth and left/right from the neutral position, and that causes an aerial work vehicle to perform a traveling operation to move forward, backward, and stop as the control stick tilts back/forth and a steering operation to steer as the control stick tilts in the left/right directions; and an enable switch that is located in a position where the enable switch can be pressed by the same fingers as those gripping and tilting the control stick, and that enables the traveling operation and steering operation only when pressed.

### FIELD OF THE INVENTION

The present invention relates to a drive operating device of an aerial work platform, and in more detail relates to a control panel to which the drive operating device constituted of, for example, a lever or the like for an operator who rides on a deck to drive an aerial work platform is consolidated, in a self-propelled aerial work platform. The self-propelled aerial work platform includes traveling devices, such as caterpillars and wheels, the deck on which the operator rides above an undercarriage including a driving source to drive the traveling devices, and an elevating mechanism to cause the deck to move up and down above the undercarriage.

### BACKGROUND OF THE INVENTION

As illustrated in FIG. 7, an aerial work platform 100 includes traveling devices (wheels in the illustrated example) 105, such as caterpillars and wheels, a deck 104, and an elevating mechanism (a scissors link mechanism in the illustrated example) 103. The deck 104 is moved up and down while an operator or the like rides on an undercarriage 102, which includes a driving source (not illustrated), such as an engine and a motor, that drives the traveling devices 105. The elevating mechanism 103 is to move up and down the deck 104 above the undercarriage 102. The operator operates a control panel 110 (referred to as a “control panel” in this specification) to which a drive operating device 120 constituted of a lever, a switch, and the like installed on the deck 104 is consolidated to ensure driving the aerial work platform 100, thus enhancing mobility of the aerial work platform 100.

As illustrated in FIG. 8, the control panel 110 as the drive operating device 120 disposed on the aerial work platform 100 that includes a travel operation lever 125 and a turning amount operation dial 126 has been proposed. The travel operation lever 125 is tilted in a front-rear direction to perform a travel operation that causes the aerial work platform 100 to advance, retreat, and stop corresponding to the tilt direction. The turning amount operation dial 126 is rotated in a right or left direction from a neutral position to operate a turning direction and an amount of turning of the aerial work platform 100 according to the rotation direction and the amount of rotation (see FIG. 3 in Patent Document 1).

Additionally, as illustrated in FIG. 9, the drive operating device 120 that includes one lever 127 tiltable to the front, the rear, the left, and the right, and allows simultaneously performing a travel operation and an operation of turning right and left (a steering operation) of the aerial work platform 100 by operating the lever 127 has also been proposed (see FIG. 1 in Patent Document 2).

### RELATED ART DOCUMENTS

[Patent Document]

[Patent Document 1] Japanese Patent No. 6080458

[Patent Document 2] Japanese Patent KOKAI No. H8-142873 (LOPI; automatically published after around 18 months from filing date regardless prosecution)

### SUMMARY OF THE INVENTION

### Problems to be Solved by the Invention

As illustrated in FIG. 7, in the above-described aerial work platform 100, the above-described control panel 110 is generally installed at a position where the operator standing on the deck 104 easily performs the operation, such as an upper end part of a safety barrier 140 disposed on the deck 104. The standing operator operates the drive operating device 120 disposed in the control panel 110 to drive the aerial work platform 100.

Therefore, like the control panel 110 described in Patent Document 1, which has been described with reference to FIG. 8, in the configuration of a drive operating device 120 in which each of the travel operation lever 125, which performs the travel operation, such as the advance, the retreat, and the stop of the aerial work platform, and the turning amount operation dial 126, which is to operate the amount of turning of the aerial work platform 100, is disposed separately, since the operator operates the travel operation lever 125 by one hand and the turning amount operation dial 126 by the other hand during the driving of the aerial work platform 100, both hands are full during the driving.

While both hands are thus full, the operator cannot support the body by, for example, holding on to the safety barrier 140, and the driving while absorbing swing during the traveling by feet is necessary. Thus, not only requiring proficiency in the driving, in a case where the aerial work platform 100 swings hard by, for example, climbing over a step difference or colliding with an obstacle, the body cannot be fully supported, possibly causing the operator to fall on the deck 104.

In contrast to this, the drive operating device 120 described in Patent Document 2 described with reference to FIG. 9 allows the travel operation, such as the advance and the retreat of the aerial work platform 100, and the steering operation, such as the turning right and left, can be simultaneously performed with one lever 127. Therefore, it is convenient in that the operator can prepare for, for example, a vibration and an impact by, for example, while operating the lever 127 by one hand, holding on to the safety barrier 140 by the other empty hand.

However, the drive operating devices 120 in neither Patent Document 1 nor Patent Document 2 includes a configuration to reduce an erroneous operation. Therefore, in a case where the aerial work platform 100 is stopped, and a high-place work, such as installation of a lighting apparatus on, for example, a ceiling, is performed, when a part of the body of the operator erroneously touches the travel operation lever 125 or the lever 127, a malfunction, such as erroneous starting of the aerial work platform 100, possibly occurs.

To reduce such a malfunction of the aerial work platform 100, it is considered to start the work in a state where a key switch (not illustrated) disposed as a main switch on the aerial work platform 100 is turned OFF after traveling and an elevating operation of the deck end and before the high-place work, such as the installation of the lighting apparatus described above, starts, or to start the high-place work in a state where an emergency stop button (not illustrated) is pressed and all operations are stopped in a case where the emergency stop button is disposed on the aerial work platform 100.

However, to resume the elevating operation of the deck 104 and the traveling for movement to the next work place, it is necessary to turn ON the main switch by the operation of the key switch or perform an operation to release the emergency stop state, and therefore the operation is complicated by the coping method.

Moreover, with the method, in a case where the high-place work starts while turning OFF of the main switch is forgotten or pressing the emergency stop button is forgotten, the erroneous operation in association with, for example, a contact with the levers 125, 127 disposed on the drive operating device 120 cannot be reduced.

As a method that reduces the erroneous operation including forgetting the operations while solving the complicated operations, for example, disposing an enable switch (not illustrated) that enables the operation of the drive operating device 120 while the switch is pressed separately from the above-described main switch and emergency stop button is considered.

However, when the enable switch is disposed on the control panel 110 together with the drive operating device 120, while the enable switch is pressed with one finger, the drive operating device 120 is operated by another finger to drive the aerial work platform 100. Thus, even employing the configuration of the drive operating device 120 described in Patent Document 2 described above, both hands of the operator are full during the driving.

To solve the problem, it is considered that the above-described enable switch is configured as a foot switch (not illustrated), the foot switch is disposed on the deck 104 at a position where the operator depresses the foot switch by the foot while operating the drive operating device 120 disposed in the control panel 110, and while the foot switch is depressed, the operation of the drive operating device 120 can be enabled.

However, with the foot switch on the deck 104, when the operator performs a work in a state of paying attention to the above, such as the installation work of the lighting apparatus to, for example, the ceiling, the foot switch is outside the field of vision, possibly involving a danger, such as tripping over the foot switch and falling.

In the aerial work platform 100, the above-described control panel 110 is generally installed in a state of being fixed to, for example, the safety barrier 140 of the deck 104. However, the inventors of the present invention have inspired that, when this is configured so as to be removably attachable and can be carried to outside the deck 104, according to working conditions, the control panel 110 can also be used as a remote controller (a remote control) for remote operation of the aerial work platform 100, and this allows the aerial work platform 100 to travel without an operator riding on the deck 104.

Thus, when the control panel 110 can be used as the remote control, in a usual application, the control panel 110 is installed to, for example, the safety barrier 140 as ever and the operator performs the driving. For example, in a case where driving while a person is onboard is risky, such as traveling when the aerial work platform 100 is loaded onto or unloaded from a vehicle carrier car, such as a self loader and a safety loader, and traveling when loading or unloading is performed on a loading platform of a motor truck using a loading ramp (an on-board slope), or in a case where the aerial work platform is caused to pass through a location difficult to pass through (a height is low) while the operator rides on the deck, such as an entrance of an elevator when the aerial work platform is loaded on the elevator and carried for use for a building work, without the riding of the operator on the deck 104, the drive operating device 120 disposed in the control panel 110 can be operated outside the deck 104 for traveling.

However, as described above, the configuration that uses the enable switch as the foot switch cannot operate the foot switch (the enable switch) unless the operator rides on the deck 104, thereby failing to cause the control panel 110 to function as the above-described remote control.

Meanwhile, the configuration that includes the above-described enable switch on the control panel 110 allows operating the enable switch even when the control panel 110 is removed from the deck and carried to outside the deck 104.

However, the existing control panel 110 has a comparatively large box shape, and even an adult male need to carry the control panel 110 with holding the control panel 110 in an arm. The addition of the enable switch to the control panel 110 makes it difficult to simultaneously operate both of a drive operating device 120 and the enable switch while holding the control panel 110, and after all, the control panel 110 cannot be used as the remote control.

Thus, the present invention has been made to solve a new problem assumed in a case of employing a configuration in which an enable switch is added to the control panel 110 of the conventional aerial work platform that includes the drive operating device 120 introduced as Patent Document 1 and Patent Document 2 and further a new problem assumed in a case of a configuration in which the control panel 110 is removably attachable to the deck (for example, the safety barrier 140 of the deck) in addition to the configuration of adding the enable switch. An object of the present invention is to provide a control panel that is operable by one hand even when the enable switch is added, and allows easily driving an aerial work platform while the control panel 110 is held with fingers even in use by a novel method, which has not existed up to the present, of use as a remote control by removal from a deck.

### Means for Solving the Problem

Means for solving the problems are described below with reference numerals used in the detailed description of the preferred embodiments. These reference numerals are intended to clarify the correspondence between the descriptions in the claims and the descriptions in the detailed description of the preferred embodiments, and it is needless to say that these reference numerals should not be used to restrictively interpret the technical scope of the present invention.

In order to achieve the above object, a control panel 10 of aerial work platform 1 of the present invention disposed on a deck 4 of a self-propelled aerial work platform 1, the aerial work platform 1 including a traveling device 5 (wheels in the illustrated example), an undercarriage 2, and the deck 4 configured to move up and down above the undercarriage 2, the undercarriage 2 including a driving source such as crawlers, wheels (not illustrated) that drives the traveling device 5 such as a motor, the control panel 10 comprises:
a drive operating device 20 that includes an operation rod 21 on the control panel 10, a tilt operation from a neutral position in front, rear, left, and right directions being performable on the operation rod 21, the operation rod 21 performing a travel operation that causes the aerial work platform 1 to advance, retreat, and stop in accordance with the tilt in the front-rear direction, the operation rod 21 causing the aerial work platform 1 to perform a steering operation in accordance with the tilt in the right-left direction; and
an enable switch 22 disposed on the operation rod 21, the travel operation and the steering operation being enabled only while the enable switch 22 is pressed, wherein
the enable switch 22 is disposed at a position where the tilt operation is performable on the operation rod 21 while the enable switch 22 is pressed with fingers same as fingers gripping the operation rod 21 (See FIGS. 1 to 6).

The control panel 10 may be installed on the deck 4, and at least a control panel main body 11 including the drive operating device 20 is removably attachable to the deck 4 in the control panel 10 so that the control panel main body 11 may be usable as a remote controller to remotely travel the aerial work platform 1 when the control panel main body 11 is removed from the deck 4 (See FIGS. 1 to 4 and 6).

The enable switch 22 may be disposed on a side surface on a front side of a gripping portion 24 of the operation rod 21 (See FIG. 3(B)).

Furthermore, an acceleration switch 23 disposed on the operation rod 21 of the drive operating device 20 may be provided at a position where the acceleration switch 23 is operable simultaneously with the enable switch 22 by fingers same as fingers gripping the operation rod 21 while the operation rod 21 is gripped and operated, the acceleration switch 23 switching a travel speed stage of the aerial work platform 1 in accordance with the travel operation between a low speed stage and a high speed stage (See FIGS. 3 and 4).

The acceleration switch 23 may be disposed on a top surface of the gripping portion 24 of the operation rod 21 (See FIGS. 3 and 4).

The control panel 10 may comprise an attachment/removal detection means (herein after called “detector”) 25 that detects the removal of the control panel main body 11 from the deck 4, the attachment/removal detector 25 causing a controller 70 that controls an operation of the driving source disposed on the aerial work platform 1 to perform a process of decelerating a travel speed of the aerial work platform 1 in accordance with the travel operation while the removal of the control panel main body 11 from the deck 4 is detected (see FIG. 5).

When the operation rod 21 is recovered to the neutral position in the right-left direction, the steering operation that sets steering wheels disposed on the undercarriage 2 at a straight ahead position may be caused to be performed.

### Effect of the Invention

The configuration of the present invention that has been described above has allowed to obtain the following remarkable effects from the aerial work platform 1 including the control panel 10 of the present invention.

The enable switch 22 that enables the travel operation and the steering operation only while the enable switch 22 is pressed is disposed on the operation rod 21 of the drive operating device 20, and the enable switch 22 is disposed at the position where the enable switch 22 can be simultaneously pressed with the fingers same as the fingers gripping the operation rod 21 while the operation rod 21 is gripped and operated. Accordingly, while the configuration includes the enable switch 22, the driving of the aerial work platform 1 can be performed by one hand.

As a result, when the control panel 10 of the present invention is installed on the deck 4 for use, while the operator performs the driving by one hand, the operator can perform the driving while holding on to the safety barrier 40 with fingers of the other hand, thus ensuring the driving in the stable posture.

Additionally, the drive operating device 20 can be thus operated by one hand. Therefore, although the above-described enable switch 22 is disposed, even in a case where the operator removes the control panel main body 11 including at least the drive operating device 20 in the control panel 10 from the deck 4 and operates the drive operating device 20 with holding the control panel main body 11 in the arm, the operator can operate the drive operating device 20 by one hand. Consequently, the control panel main body 11 of the present invention can be used also as the remote controller used for traveling the aerial work platform 1 by remote travel.

Disposing the enable switch 22 as, for example, the trigger switch on the side surface on the front side of the gripping portion 24 of the operation rod 21 allows extremely easily performing the gripping of the operation rod 21 and the operation of the enable switch 22 simultaneously and naturally performing the operations without forcing the hands of the operator to take an unnatural posture, thus ensuring reducing a fatigue of the operator.

The travel speed of the aerial work platform 1 can be easily accelerated in the configuration in which the acceleration switch 23, which switches the travel speed stage of the aerial work platform 1 in accordance with the travel operation between the low speed stage and the high speed stage, is disposed on the operation rod 21 of the drive operating device 20 at the position where the acceleration switch 23 is operable simultaneously with the enable switch 22 by the fingers same as the fingers gripping the operation rod 21 while gripping and operating the operation rod 21.

Especially, the following control panel 10 can be provided. The configuration of disposing the acceleration switch 23 on the top surface of the gripping portion 24 of the operation rod 21 allows effortlessly operating the enable switch 22 and the acceleration switch 23 simultaneously, and the configuration allows simultaneous operation of the plurality of switches by one hand without forcing the hands of the operator to take the unnatural posture, and therefore the control panel 10 is operable without excessively fatiguing the operator.

In the configuration of providing the attachment/removal detector 25 that causes the controller 70, which controls the operation of the driving source disposed in the aerial work platform 1, to perform the process of decelerating the travel speed of the aerial work platform 1 in accordance with the travel operation while the removal of the control panel main body 11 is detected and the removal of the control panel main body 11 from the deck 4 is detected, the control panel main body 11 is used as the remote control, and the remote travel of the aerial work platform 1 performed from outside the deck by the operator who has got out the aerial work platform 1 can be further safely performed.

In the configuration that recovers steering wheels disposed on the undercarriage to the straight ahead position when the operation rod 21 is recovered to the neutral position in the right-left direction, the steering operation of the aerial work platform 1 can be further easily performed.

### BRIEF DESCRIPTION OF THE DRAWINGS

FIG. 1 is a side view of an aerial work platform that includes a control panel of the present invention;

FIG. 2 is a perspective view of the aerial work platform that includes the control panel of the present invention;

FIG. 3(A) is a plan view, FIG. 3(B) is a left side view, and FIG. 3(C) is a back view of the control panel of the present invention;

FIG. 4 is a perspective view of the control panel of the present invention;

FIG. 5 is a function block diagram of the aerial work platform that includes the control panel of the present invention;

FIG. 6 is a plan view illustrating a usage state of removing the control panel (a control panel main body);

FIG. 7 is a side view of a general aerial work platform;

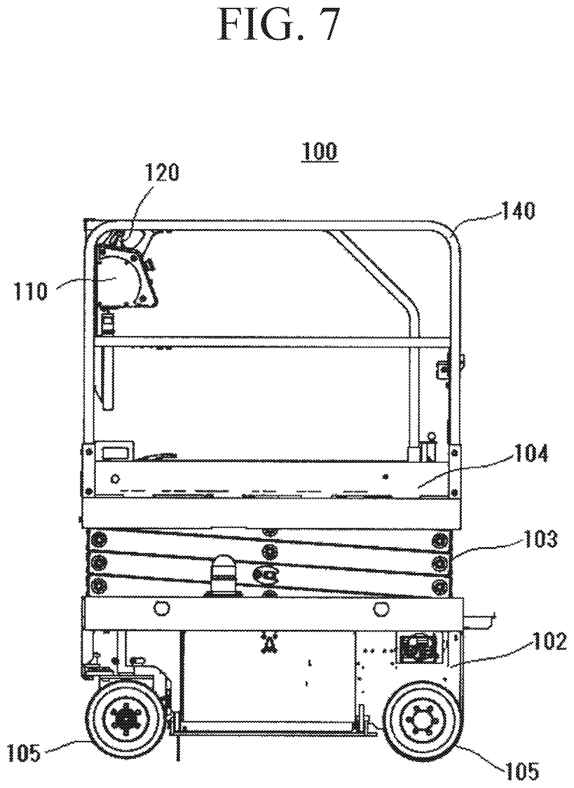

FIG. 8 is an explanatory view of a conventional drive operating device (corresponds to the configuration in FIG. 3 in Patent Document 1); and

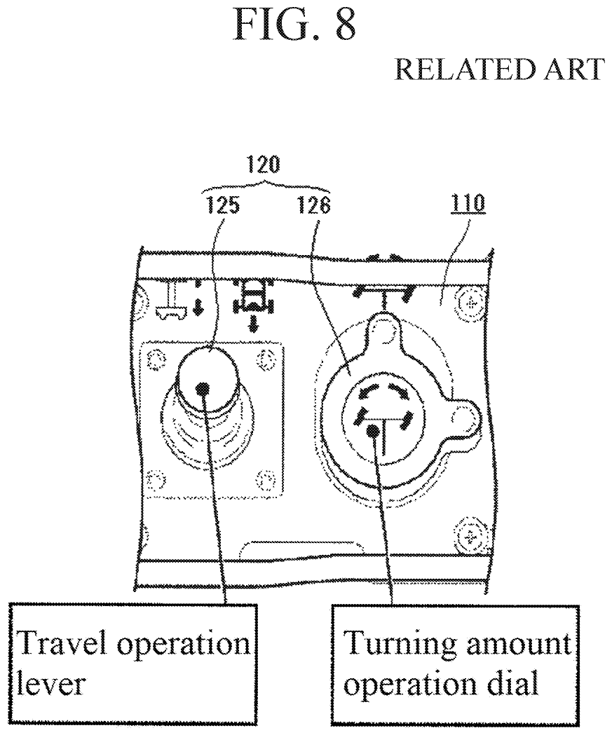

FIG. 9 is an explanatory view of a conventional drive operating device (corresponds to FIG. 1 in Patent Document 2).

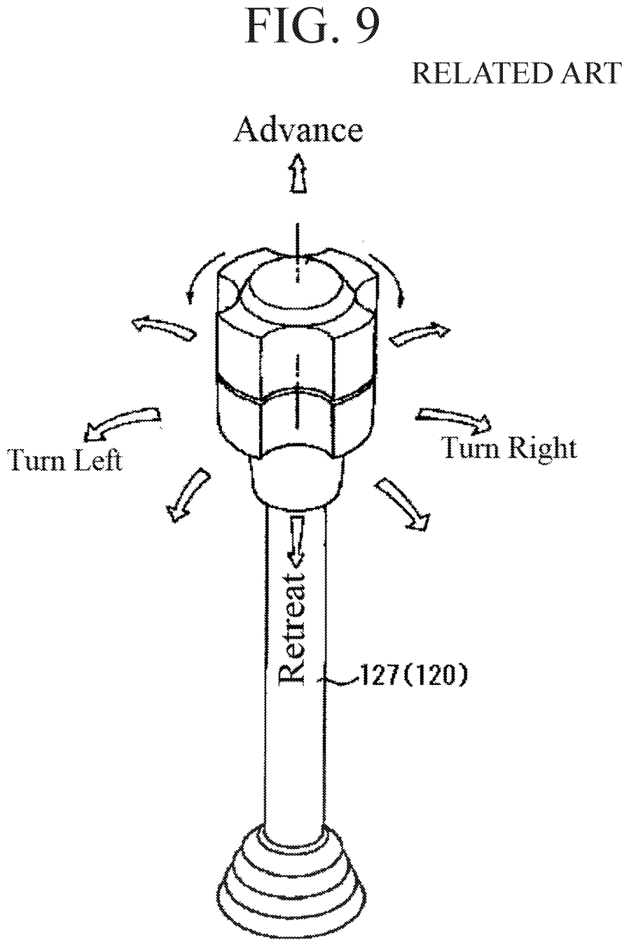

### EMBODIMENTS FOR CARRYING OUT THE INVENTION

The following will describe a configuration of the present invention with reference to the attached drawings.

### [Overall Configuration of Aerial Work Platform]

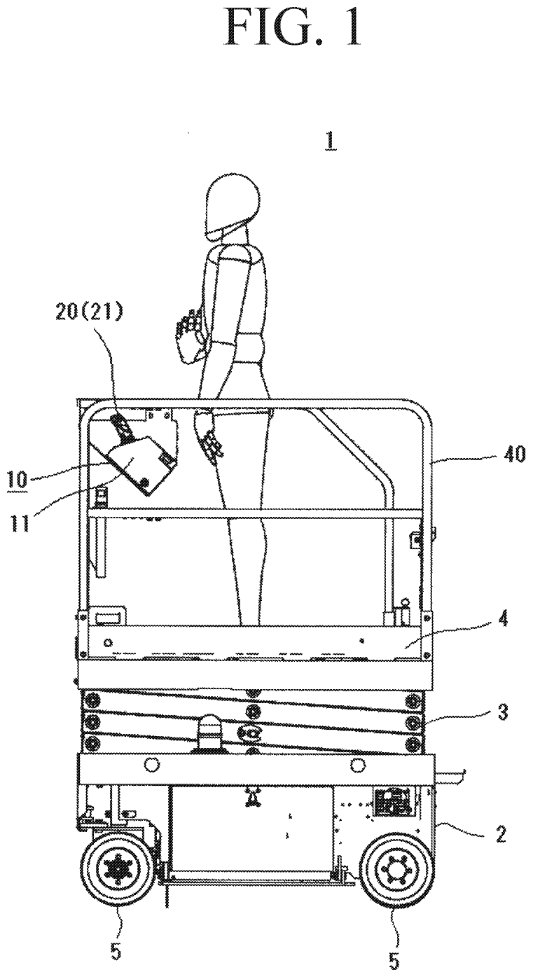

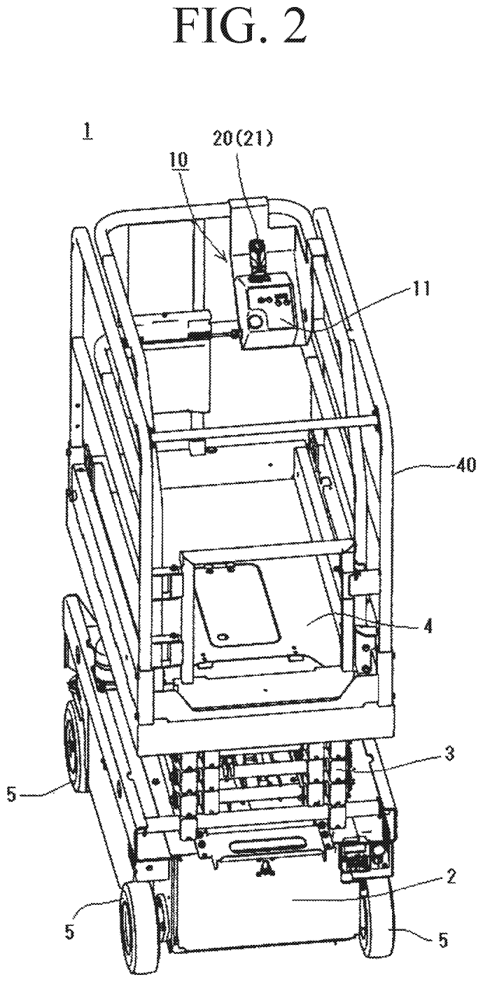

In FIG. 1 and FIG. 2, reference numeral 1 denotes an aerial work platform that includes a control panel 10 of the present invention. The aerial work platform 1 includes an undercarriage 2 and a deck 4. The undercarriage 2 includes traveling devices (wheels in the illustrated example) 5, such as wheels and caterpillars, on respective both sides in a width direction. The deck 4 above the undercarriage 2 moves up and down via an elevating mechanism 3 formed of a scissors link mechanism.

For example, by disposing a safety barrier 40 on the deck 4, falling of, for example, an operator and luggage riding on the deck 4 is reduced.

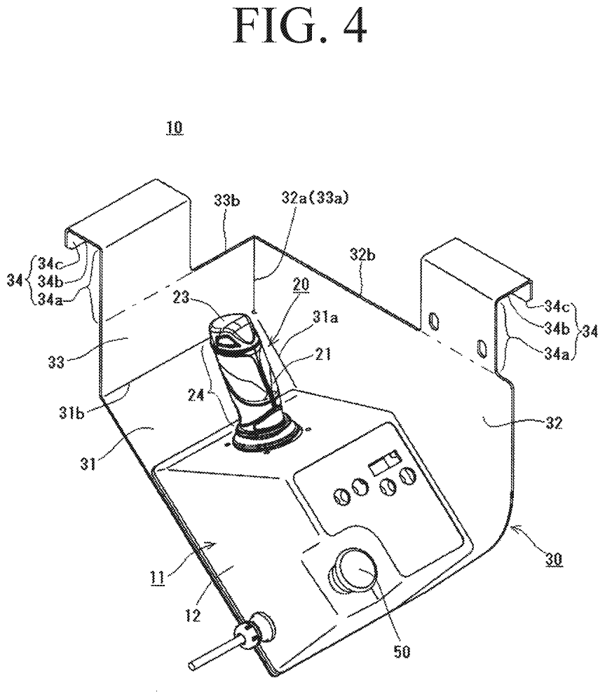

In the embodiment illustrated in the drawings, as one example of the aerial work platform 1 that includes the control panel 10 of the present invention, the aerial work platform 1 having the structure configured to move up and down the deck by the elevating mechanism 3 formed of the scissors link mechanism has been described, however the control panel 10 of the present invention is applicable to the various kinds of known aerial work platforms, such as the aerial work platform as described in Patent Document 1 (see FIG. 1 in Patent Document 1) described above in which a box-shaped deck is installed to a crane distal end of a crane truck to be movable up and down, and an aerial work platform as described in Patent Document 2 (see FIG. 4 in Patent Document 2) described above in which a deck can be moved up and down with a mast having a telescopic structure that is perpendicularly disposed upright on an undercarriage and vertically extends.

### [Control Panel]

### (1) Overall Configuration of Control Panel 10

In FIG. 1 and FIG. 2, reference numeral 10 denotes the control panel 10 installed in the proximity of the upper end of the safety barrier 40 at one end side of the deck 4. Operating a drive operating device 20 disposed in the control panel 10 by the operator who rides on the deck 4 allows performing a travel operation, such as advance, retreat, and stop, of the aerial work platform 1 and a steering operation of operating steering wheels.

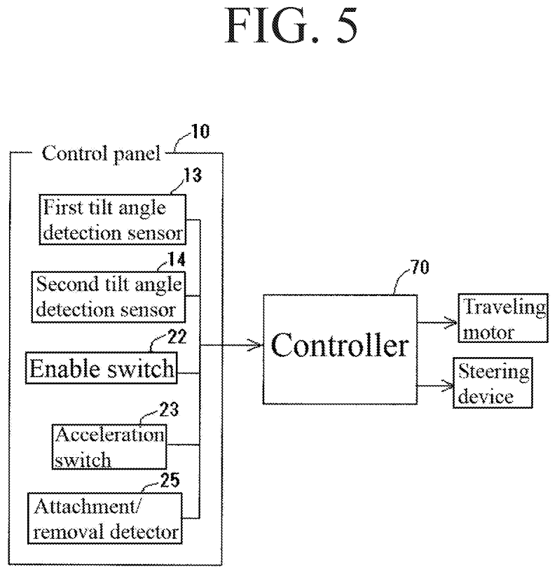

As illustrated in FIG. 5, various kinds of operation commands input via the control panel 10 are input to a controller 70 configured of an electronic control device, such as a microcontroller. The controller 70 controls the operations of a traveling motor and a steering device to ensure the travel control and steering control of the aerial work platform 1 in accordance with the operation performed via the drive operating device 20 by the operator.

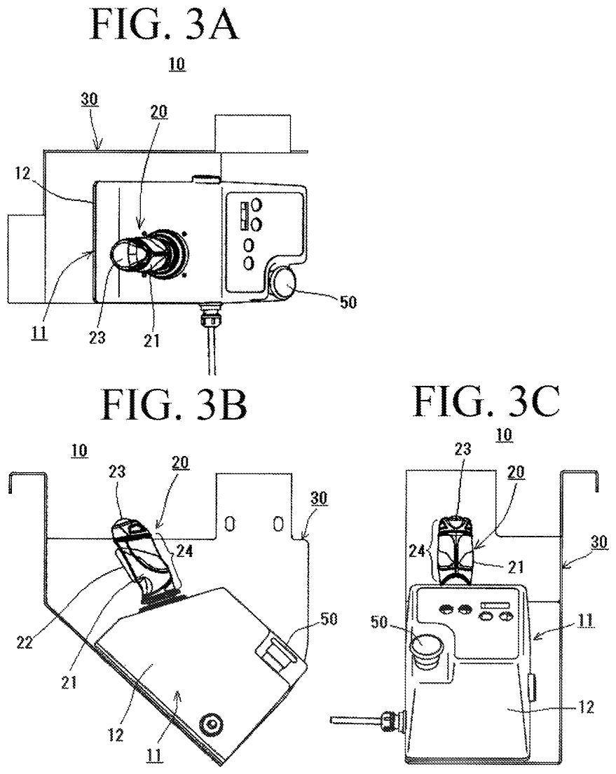

As illustrated in FIG. 3 and FIG. 4, the control panel 10 includes a control panel main body 11, the drive operating device 20, and a bracket 30. The control panel main body 11 is formed by housing components in a casing 12. The drive operating device 20 is disposed in the control panel main body 11 to perform the travel control and the steering control of the aerial work platform 1. With the bracket 30, the control panel main body 11 is installed to the safety barrier 40.

In the embodiment illustrated in the drawings, the control panel main body 11 includes only the above-described drive operating device 20 and an emergency stop switch indicated by reference numeral 50 as a lever, a switch, and the like to operate the aerial work platform 1. However, the control panel main body 11 may further include a switch, a lever, and the like to cause the elevating mechanism 3 to perform the elevating operation of the deck 4. Alternatively, it may be configured that a selector switch to switch between the driving operation and the elevating operation is disposed, and when the elevating operation is selected with the selector switch, the elevating operation of the deck can be performed by the operation of an operation rod 21 of the drive operating device 20.

### (2) Drive Operating Device

The above-described drive operating device 20 that performs the travel control and the steering control of the aerial work platform 1 includes the operation rod 21, an enable switch 22 installed on the operation rod 21, and an acceleration switch 23.

The operation rod 21 among them is configured swingably in the front, rear, left, and right directions starting from a neutral position. The aerial work platform 1 can be advanced by tilting the operation rod 21 forward, can be retreated by tilting the operation rod 21 backward, and can be stopped by returning the operation rod 21 to the neutral position. By tilting the operation rod 21 in the right direction, the steering wheels can be turned in the right direction. By tilting the operation rod 21 in the left direction, the steering wheels can be turned in the left direction.

In the operation rod 21, a grip rubber or the like is installed to a part gripped by the operator to form a grip portion 24 [see FIG. 3(B), FIG. 3(C), and FIG. 4], and the operator grips the grip portion 24 to perform the tilt operation on the operation rod 21, thus allowing the aerial work platform 1 to travel in the desired direction and steering angle.

The operation rod 21 includes the above-described enable switch 22 and acceleration switch 23.

The enable switch 22 among them is configured of a momentary type switch. While a user presses the enable switch 22, the travel operation and the steering operation in accordance with the tilt operation of the operation rod 21 is enabled.

Similarly to the enable switch 22, the above-described acceleration switch 23 is configured of a momentary type switch or the like. Only while the acceleration switch 23 is pressed, a travel speed at a low speed stage, which is a travel speed of the aerial work platform 1 based on the travel operation performed by the tilt operation in the front-rear direction of the operation rod 21 while the acceleration switch 23 is not pressed, is switched to a predetermined travel speed at a high speed stage.

In this embodiment, pressing the acceleration switch 23 while the operation rod 21 is not returned to the neutral position but is tilted in any of the front and rear directions allows switching the travel state at the usual speed (the low speed stage) to the travel speed (the high speed stage) accelerated without temporarily stopping the aerial work platform 1.

The above-described acceleration switch 23 is not limited to the momentary type switch, however may be configured such that, for example, a pressing button may be used, the pressed state may be maintained by one push (the high speed stage), and the pressed state may be released from the pressed state to recover to the original position (the low speed stage) by two pushes.

Both of the above-described enable switch 22 and the acceleration switch 23 are disposed at the positions on the operation rod 21 where the operator can simultaneously press the enable switch 22 and the acceleration switch 23 with the fingers same as the fingers gripping the grip portion 24 with the grip portion 24 of the operation rod 21 gripped.

In this embodiment, as illustrated in FIG. 3(B), the above-described enable switch 22 is disposed on a side surface on the front side of the grip portion 24 of the operation rod 21 as a trigger switch. By gripping the grip portion 24 with a ball of a finger on the enable switch 22, while the enable switch 22 is pressed, the operation rod 21 can be gripped.

As illustrated in FIG. 3 and FIG. 4, in this embodiment, the above-described acceleration switch 23 is disposed on the top surface of the grip portion 24 of the operation rod 21. Even when the enable switch 22 is pressed with the grip portion 24 gripped, the acceleration switch 23 can be easily operated by the thumb.

The locations of the above-described enable switch 22 and acceleration switch 23 may be the opposite.

### (3) Control Panel Main Body

The above-described casing 12 of the control panel main body 11 including the drive operating device 20 houses devices, such as the various sensors and the electronic control device, required to perform the driving operation of the aerial work platform 1 input by the operation of the above-described drive operating device 20.

As one example of the housing device, the above-described casing 12 internally houses a first tilt angle detection sensor 13 and a second tilt angle detection sensor 14 (see FIG. 5 for both of them). The first tilt angle detection sensor 13 and the second tilt angle detection sensor 14 are coupled to the lower end portion of the operation rod 21 passing through the casing 12 and inserted into the casing 12, thus ensuring detecting tilt angles in the front, rear, left, and right directions of the operation rod 21.

In the above-described casing 12, biasing means (not illustrated) that biases the operation rod main body 21 to return the operation rod main body 21 to the neutral position is disposed. When the operation rod main body 21 is released from a state of being tilted in any of the front, rear, left, and right directions, the operation rod main body 21 automatically returns to the neutral position.

The above-described first tilt angle detection sensor 13 detects the tilt angle in the front-rear direction of the operation rod 21, and the controller 70 controls the rotation direction and the rotation speed of the traveling motor disposed in the undercarriage in accordance with the tilt angle detected by the first tilt angle detection sensor 13. When the tilt operation is performed on the operation rod 21 forward, the aerial work platform 1 is caused to travel forward at the speed according to the angle inclined forward, when the tilt operation is performed on the operation rod 21 backward, the aerial work platform 1 is caused to travel backward at the speed according to the angle inclined backward, and when the operation rod 21 is at the neutral position, the traveling motor is stopped to stop the traveling of the aerial work platform 1.

Note that the above-described controller 70 may be disposed in the casing 12 together with the first and second tilt angle detection sensors 13, 14 or may be mounted on, for example, the undercarriage 2 side separately from the first and second tilt angle detection sensors 13, 14.

The second tilt angle detection sensor 14 detects the tilt angle in the right-left direction of the operation rod 21, and the controller 70 operates the steering device (not illustrated) disposed on the undercarriage 2 to control the steering angle of the steering wheels in accordance with the tilt angle detected by the second tilt angle detection sensor 14. When the tilt operation is performed on the operation rod 21 rightward, the steering wheels are steered in the right turning direction according to the tilt angle, when the tilt operation is performed on the operation rod 21 leftward, the steering wheels are steered in the left turning direction according to the tilt angle, and when the operation rod 21 is at the neutral position, the steering wheels are caused to recover to the advance position.

The above-described example has described the configuration of detecting the tilt angle of the operation rod 21 and driving the aerial work platform 1 at the speed and the steering angle according to the tilt angle, however instead of the configuration, the following configuration may be employed. A sensor (not illustrated) that does not detect the tilt angle of the operation rod 21, however detects only the tilted direction (front inclination, rear inclination, and neutral, and the right inclination, left inclination, and neutral) is disposed. When the operation rod 21 is tilted in the forward direction, regardless of the tilt angle, the aerial work platform 1 advances at a constant speed, when the operation rod 21 is tilted backward, regardless of the tilt angle, the aerial work platform 1 retreats at a constant speed, and when the operation rod 21 is at the neutral position, the traveling is stopped. When the operation rod 21 is tilted rightward, the steering angle of the steering wheels is increased at a constant speed in the right turning direction during the tilt, when the operation rod 21 is tilted leftward, the steering angle of the steering wheels is increased at a constant speed in the left turning direction during the tilt, and when the operation rod 21 is returned to the neutral position, the steering operation is stopped and the steering angle when the operation rod 21 is returned to the neutral position is held (is not returned to the straight ahead position). The known travel operation and steering operation employed by the aerial work platform 1 can be performed.

### (4) Bracket

As the above-described bracket 30 to install the above-described control panel main body 11 to the safety barrier 40, in this embodiment, as illustrated in FIG. 4, a back surface plate 31 that forms an inclined surface on which the back surface of the control panel main body 11 is placed, a side surface plate 32 disposed upright in a perpendicular direction on one side 31a in the width direction of the back surface plate 31, and a front surface plate 33 disposed upright in a perpendicular direction on an upper end side 31b of the back surface plate 31 are provided. One side 33a in the width direction of the front surface plate 33 is orthogonally coupled to one side 32a in a height direction of the side surface plate 32.

In each of an upper end side 33b of the front surface plate 33 and an upper end side 32b of the side surface plate 32, a suspension metal fitting 34 formed of a suspension piece 34a that projects upward, a lock piece 34b that projects outward from an upper end of the suspension piece 34a in the horizontal direction, and a collar portion 34c that projects downward from the other end edge of the lock piece 34b are disposed. By inserting and fitting the upper end portion of the safety barrier 40 disposed upright on the deck 4 into the U-shaped parts opening downward surrounded by the upper end portions of the suspension pieces 34a, the lock pieces 34b, and the collar portions 34c of the suspension metal fittings 34, the control panel 10 can be installed in the proximity of the upper end of the safety barrier 40 in a suspended state.

In this embodiment, with the above-described suspension metal fittings 34, the control panel 10 can be installed to the corner portion of the safety barrier 40. By only hooking the two suspension metal fittings 34, 34 on the upper end portion of the safety barrier 40, without fixing, such as fastening with a bolt, the control panel 10 can be installed so as not to, for example, move the control panel 10 on the safety barrier 40, and by only lifting the control panel 10, the control panel 10 can be easily removed from the safety barrier 40.

In the embodiment illustrated in the drawing, the configuration in which the control panel main body 11 can be removed from the safety barrier 40 of the deck 4 integrally with the bracket 30 has been described. Instead of the configuration, for example, as a configuration in which the above-described bracket 30 is fixedly secured to the safety barrier 40 by a method, such as fastening with a bolt, and the control panel main body 11 is installed to the bracket 30 to be removably attachable, when the control panel main body 11 is removed from the safety barrier 40, any component of the control panel 10 including the bracket 30 and accessories disposed in the bracket 30 as a part of the control panel 10 (for example, attachment/removal detector 25 described later in a case of installation to the safety barrier 40 side) may remain on the safety barrier 40 side of the deck 4. Note that the control panel 10 of the present invention can include the attachment/removal detector 25 (see FIG. 5) that detects the attachment/removal state of the control panel main body 11 to the safety barrier 40. As described above, in the embodiment illustrated in the drawing in which the bracket 30 is removed from the safety barrier 40 integrally with the control panel main body 11, the following configuration may be employed. As one example, a limit switch, a proximity sensor, or the like is disposed as the attachment/removal detector 25 on, for example, the above-described lock piece 34b of the suspension metal fitting 34 of the bracket 30. When the suspension metal fittings 34 are hooked on the upper end portion of the safety barrier 40, the attachment/removal detector 25 detects the presence of the upper end portion of the safety barrier 40, and the above-described attachment/removal detector 25 can detect that the control panel 10 is installed to the safety barrier 40 or is removed.

As long as the attachment/removal of the control panel main body 11 can be detected, the above-described attachment/removal detector 25 is not limited to the configuration of being disposed on the bracket 30 side and may be disposed on the safety barrier 40 side.

As described above, in the configuration in which the control panel main body 11 is removably attachable to the bracket 30, the attachment/removal detector 25 may be disposed on the control panel main body 11 side, or may remain on the safety barrier 40 side together with the bracket 30 when the attachment/removal detector 25 is disposed on the bracket 30 side and the control panel main body 11 is removed.

A detection signal that thus has detected the attachment/removal state of the control panel 10 to the safety barrier 40 is input to the controller 70, and when the control panel 10 is removed from the safety barrier 40 and used. The controller 70 may apply a predetermined decelerated travel speed to a travel speed applied when the control panel 10 installed to the safety barrier is used.

### (5) Operation Method of Control Panel or the Like

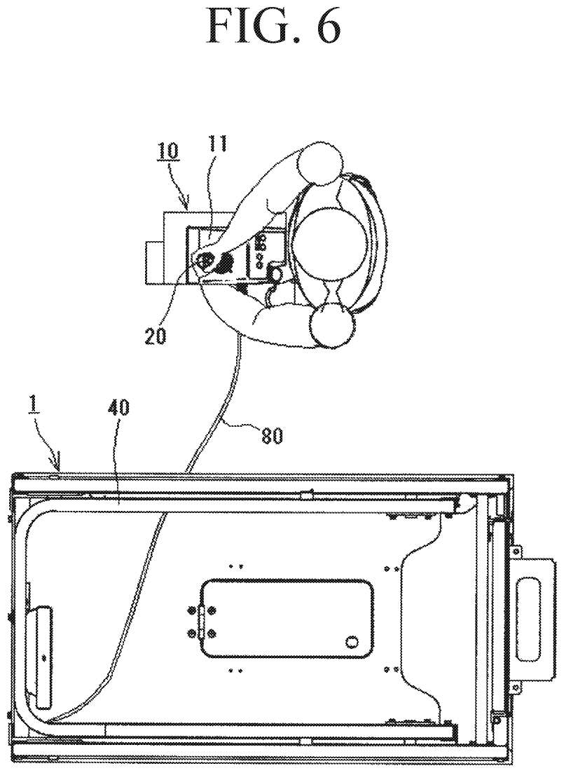

Not only that the control panel 10 of the present invention configured as described above is usable in the state of being installed to the safety barrier 40 of the deck 4 similarly to the known control panel, the control panel main body 11 can be removed from the safety barrier 40, carried to outside the deck 4, and used as a remote control for remote travel of the aerial work platform 1 (see FIG. 6).

In use according to any aspect, when the operator grips the grip portion 24 of the operation rod 21 such that the enable switch 22 disposed as the trigger switch contacts the ball of the finger, the enable switch 22 is pressed, thus enabling the driving operation by the tilt of the operation rod 21.

In the state, the operator tilts the operation rod 21 forward or backward to advance or retreat the aerial work platform, and tilts the operation rod 21 rightward or leftward to perform the steering operation of the aerial work platform 1.

When the operator operates the operation rod 21 with the enable switch 22 pressed and further with the acceleration switch 23 pressed by the thumb, the predetermined accelerated travel speed (the high speed stage) is applied to the travel speed (the low speed stage) while the acceleration switch 23 is not pressed.

As illustrated in FIG. 6, in a case where the control panel main body 11 is re moved from the safety barrier 40 and used as the remote control, the operator performs the operation with the control panel main body 11 held in the arm. However, as described above, since the operation rod 20 disposed in the control panel main body 11 is designed such that the operator can easily operate by one hand, even when the control panel main body 11 is held in the arm, the travel operation of the aerial work platform 1 can be easily performed by one hand.

Thus, the control panel main body 11 can be removed from the safety barrier 40 and used as the remote control. Therefore, although in use for usual application, the control panel main body 11 is installed to the safety barrier 40 and the operator performs the driving as in conventional case. In a case where driving while a person is onboard is risky, such as traveling when the aerial work platform 1 is loaded onto or unloaded from a vehicle carrier car, such as a self loader and a safety loader, and traveling when loading or unloading is performed on a loading platform of a motor truck using a loading ramp (an on-board slope), or the similar case, or in a case where the aerial work platform 1 is caused to pass through a location difficult to pass through (a height is low) while the operator rides on the deck 4, such as an entrance of an elevator when the aerial work platform 1 is loaded on the elevator and carried for use for a building work, without the riding of the operator on the deck 4, the operation rod 20 disposed on the control panel main body 11 can be operated outside the deck 4 for traveling.

As described above, in the configuration of disposing the attachment/removal detector 25 (see FIG. 5) that detects whether the control panel main body 11 is installed to the safety barrier 40, when the attachment/removal detector 25 detects that the control panel main body 11 is removed, that is, the control panel main body 11 is used as the remote controller, the predetermined decelerated travel speed is automatically applied, thus ensuring safely traveling the aerial work platform even in the case of remote travel.

In the illustrated embodiment (see FIG. 6), a cable 80 is coupled to the control panel main body 11 and is coupled to a main controller (not illustrated) or the like disposed on the undercarriage 2 through the deck 4 and the elevating mechanism 3 for wired remote operation. However, instead of the configuration, the control panel main body 11 may be wirelessly coupled to the main controller (not illustrated) to allow the aerial work platform 1 to perform a wireless remote operation.

### DESCRIPTION OF REFERENCE NUMERALS

1. Aerial work platform
2. Undercarriage
3. Elevating mechanism (scissors link mechanism)
4. Deck
5. Traveling device (wheels)
10. Control panel
11. Control panel main body
12. Casing
13. First tilt angle detection sensor
14. Second tilt angle detection sensor
20. Drive operating device
21. Operation rod
22. Enable switch
23. Acceleration switch
24. Grip portion
25. Attachment/removal detector
30. Bracket
31. Back surface plate
31a. One side in the width direction (of the back surface plate)
31b. Upper end side (of the back surface plate)
32. Side surface plate
32a. One side in a height direction (of the side surface plate)
32b. Upper end side (of the side surface plate)
33. Front surface plate
33a. One side in the width direction (of the front surface plate)
33b. Upper end side (of the front surface plate)
34. Suspension metal fitting
34a. Suspension piece
34b. Lock piece
34c. Collar portions
40. Safety barrier
50. Emergency stop switch
70. Controller
80. Cable
100. Aerial work platform
102. Undercarriage
103. Elevating mechanism (scissors link mechanism)
104. Deck
105. Traveling device (wheel)
110. Control panel
120. Drive operating device
125. Travel operation lever
126. Turning amount operation dial
127. Lever
140. Safety barrier

1. A control panel of aerial work platform disposed on a deck of a self-propelled aerial work platform, the self-propelled aerial work platform including a traveling device, an undercarriage, and the deck configured to move up and down above the undercarriage, the undercarriage including a driving source that drives the traveling device, the control panel comprising:
a drive operating device that includes an operation rod on the control panel, a tilt operation from a neutral position in front, rear, left, and right directions being performable on the operation rod, the operation rod performing a travel operation that causes the aerial work platform to advance, retreat, and stop in accordance with the tilt in the front-rear direction, the operation rod causing the aerial work platform to perform a steering operation in accordance with the tilt in the right-left direction; and
an enable switch disposed on the operation rod, the travel operation and the steering operation being enabled only while the enable switch is pressed,
the enable switch being disposed at a position where the tilt operation is performable on the operation rod while the enable switch is pressed with fingers same as fingers gripping the operation rod.

2. The control panel of aerial work platform according to claim 1, wherein
the control panel is installed on the deck, and at least a control panel main body including the drive operating device is removably attachable to the deck in the control panel so that the control panel main body is usable as a remote controller to remotely travel the aerial work platform when the control panel main body is removed from the deck.

3. The control panel of aerial work platform according to claim 1, wherein
the enable switch is disposed on a side surface on a front side of a gripping portion of the operation rod.

4. The control panel of aerial work platform according to claim 1, comprising
an acceleration switch disposed on the operation rod of the drive operating device at a position where the acceleration switch is operable simultaneously with the enable switch by fingers same as fingers gripping the operation rod while the operation rod is gripped and operated, the acceleration switch switching a travel speed stage of the aerial work platform in accordance with the travel operation between a low speed stage and a high speed stage.

5. The control panel of aerial work platform according to claim 4, wherein
the acceleration switch is disposed on a top surface of the gripping portion of the operation rod.

6. The control panel of aerial work platform according to claim 2, comprising
an attachment/removal detector that detects the removal of the control panel main body from the deck, the attachment/removal detector causing a controller that controls an operation of the driving source disposed on the aerial work platform to perform a process of decelerating a travel speed of the aerial work platform in accordance with the travel operation while the removal of the control panel main body from the deck is detected.

7. The control panel of aerial work platform according claim 1, wherein
when the operation rod is recovered to the neutral position in the right-left direction, the steering operation that sets steering wheels disposed on the undercarriage at a straight ahead position is caused to be performed.

8. The control panel of aerial work platform according to claim 2, wherein
the enable switch is disposed on a side surface on a front side of a gripping portion of the operation rod.

9. The control panel of aerial work platform according to claim 2, comprising
an acceleration switch disposed on the operation rod of the drive operating device at a position where the acceleration switch is operable simultaneously with the enable switch by fingers same as fingers gripping the operation rod while the operation rod is gripped and operated, the acceleration switch switching a travel speed stage of the aerial work platform in accordance with the travel operation between a low speed stage and a high speed stage.

10. The control panel of aerial work platform according to claim 3, comprising
an acceleration switch disposed on the operation rod of the drive operating device at a position where the acceleration switch is operable simultaneously with the enable switch by fingers same as fingers gripping the operation rod while the operation rod is gripped and operated, the acceleration switch switching a travel speed stage of the aerial work platform in accordance with the travel operation between a low speed stage and a high speed stage.

11. The control panel of aerial work platform according to claim 4, comprising
an acceleration switch disposed on the operation rod of the drive operating device at a position where the acceleration switch is operable simultaneously with the enable switch by fingers same as fingers gripping the operation rod while the operation rod is gripped and operated, the acceleration switch switching a travel speed stage of the aerial work platform in accordance with the travel operation between a low speed stage and a high speed stage.

12. The control panel of aerial work platform according to claim 2, wherein
when the operation rod is recovered to the neutral position in the right-left direction, the steering operation that sets steering wheels disposed on the undercarriage at a straight ahead position is caused to be performed.

13. The control panel of aerial work platform according to claim 3, wherein
when the operation rod is recovered to the neutral position in the right-left direction, the steering operation that sets steering wheels disposed on the undercarriage at a straight ahead position is caused to be performed.

14. The control panel of aerial work platform according to claim 4, wherein
when the operation rod is recovered to the neutral position in the right-left direction, the steering operation that sets steering wheels disposed on the undercarriage at a straight ahead position is caused to be performed.

15. The control panel of aerial work platform according to claim 5, wherein
when the operation rod is recovered to the neutral position in the right-left direction, the steering operation that sets steering wheels disposed on the undercarriage at a straight ahead position is caused to be performed.

16. The control panel of aerial work platform according to claim 6, wherein
when the operation rod is recovered to the neutral position in the right-left direction, the steering operation that sets steering wheels disposed on the undercarriage at a straight ahead position is caused to be performed.

17. The control panel of aerial work platform according to claim 7, wherein
when the operation rod is recovered to the neutral position in the right-left direction, the steering operation that sets steering wheels disposed on the undercarriage at a straight ahead position is caused to be performed.

18. The control panel of aerial work platform according to claim 8, wherein
when the operation rod is recovered to the neutral position in the right-left direction, the steering operation that sets steering wheels disposed on the undercarriage at a straight ahead position is caused to be performed.

19. The control panel of aerial work platform according to claim 9, wherein
when the operation rod is recovered to the neutral position in the right-left direction, the steering operation that sets steering wheels disposed on the undercarriage at a straight ahead position is caused to be performed.

20. The control panel of aerial work platform according to claim 10, wherein
when the operation rod is recovered to the neutral position in the right-left direction, the steering operation that sets steering wheels disposed on the undercarriage at a straight ahead position is caused to be performed.
